(19) United States
(12) Patent Application Publication
(10) Pub. No.: US 2016/0128147 A1
(43) Pub. Date: May 5, 2016

(54) CONTROL OF NON-SELF-EXCITING-CONVERTER

(71) Applicant: KONINKLIJKE PHILIPS N.V., Eindhoven (NL)

(72) Inventor: Akhilesh Singh TOMAR, Indore (IN)

(21) Appl. No.: 14/893,096

(22) PCT Filed: May 15, 2014
(86) PCT No.: PCT/EP2014/059947

§ 371 Date: Nov. 23, 2015

(30) Foreign Application Priority Data
May 24, 2013 (EP) 13169176.8

(51) Int. Cl. H05B 33/08; H02M 7/5383

(52) U.S. Cl. CPC H05B 33/0815; H02M 7/53832

(57) ABSTRACT

Control circuits (1) for controlling non-self-exciting converters (100) are provided with network circuits (11-16) for deriving control signals destined for the converters (100) for starting the converters (100) after zero-crossings of first signals that enter the converters (100). These control signals are derived from the first signals. The network circuits (11-16) may comprise serial connections of resistor circuits (14, 15) and main capacitors (13) and may comprise break-over-circuitry (11) for controlling switching elements (105) of the converters (100) via the control signals. The control circuits (1) may further comprise first regulator circuits (17-29) for, in dependence of the first signals, delaying the control signals to control an amount of power transferred, and may further comprise second regulator circuits (30, 31) for, in dependence of one or more load parameter signals, delaying the control signal to control an amount of power transferred.

### FIELD OF THE INVENTION

The invention relates to a control circuit for controlling a converter. The invention further relates to a device.

Examples of such a device are drivers and lamps and parts thereof.

### BACKGROUND OF THE INVENTION

US 2012/0013259 A1 discloses a light emitting diode string driver arrangement based on a single transistor converter or a double transistor converter.

Certain converters for converting a first signal that comprises a zero-crossing into a second signal that is destined for a load are of a kind that stops converting at the zero-crossing of the first signal. Such converters are known as non-self-exciting-converters.

EP2217042 A1 discloses a control circuit for controlling a converter. The converter is configured to convert a first signal comprising a zero-crossing into a second signal destined for a load. The control circuit comprises a network circuit that provides a control signal to the convertor. The control signal is derived from the first signal and serves to starting the converter after the zero-crossing of the first signal. The network circuit comprises a break-over-circuitry, a resistor circuit and a main capacitor. A common terminal of the resistor circuit and the main capacitor is coupled to one terminal of the break-over-circuitry. The other terminal of the break-over-circuitry is configured to be coupled to the converter for controlling a switching element of the converter via the control signal.

### SUMMARY OF THE INVENTION

It is an object of the invention to provide an improved control circuit for a non-self-exciting-converter. It is a further object of the invention to provide a device.

According to a first aspect, a control circuit is provided for controlling a converter, the converter being configured to convert a first signal comprising a zero-crossing into a second signal destined for a load and being of a kind that stops converting at the zero-crossing of the first signal, the control circuit comprising
a network circuit for receiving the first signal and for deriving from the first signal a control signal destined for the converter for starting the converter after the zero-crossing of the first signal.

The first signal originates for example from an output of a rectifier, such as for example a four diode bridge, and comprises zero-crossings, for example in case a bulk capacitor at the output of the rectifier is not present. In case the converter, that converts this first signal into a second signal destined for a load, stops converting at these zero-crossings of the first signal, power is no longer supplied to the load. By having added the network circuit for receiving the first signal and for deriving from the first signal the control signal destined for the converter for starting the converter after the zero-crossings of the first signal, power is also supplied after these zero-crossings. As a result, even converters that stop converting at the zero-crossing of the first signal can now be used. This is a great advantage.

An embodiment of the control circuit is defined by the network circuit comprising a serial connection for receiving the first signal and comprising break-over-circuitry, the serial connection comprising a resistor circuit and a main capacitor, a common terminal of the resistor circuit and the main capacitor being coupled to one terminal of the break-over-circuitry, another terminal of the break-over-circuitry being configured to be coupled to the converter for controlling a switching element of the converter via the control signal. Via the resistor circuit, the main capacitor is charged. As soon as the main capacitor has been charged sufficiently, the break-over-circuitry such as for example a diac experiences a so-called break-over and the control signal in the form of a pulse is supplied to the switching element of the converter for starting the converter.

An embodiment of the control circuit is defined by the network circuit further comprising a diode, the common terminal of the resistor circuit and the main capacitor being coupled to one terminal of the diode, another terminal of the diode being configured to be coupled to the converter for controlling a capacitive element of the converter. Via the diode, the capacitive element of the converter is controlled such that the capacitive element is kept discharged until the converter has been started.

An embodiment of the control circuit is defined by the resistor circuit comprising one or more resistors, and the network circuit further comprising an auxiliary capacitor coupled in parallel to at least one of the one or more resistors. This control circuit shows an improved performance.

An embodiment of the control circuit is defined by the control circuit further comprising
a first regulator circuit for in dependence of the first signal delaying the control signal. The control signal can be delayed, to control an amount of power transferred from the converter to the load. Preferably, for the first signal having a relatively small (large) amplitude, the control signal is to be delayed relatively little (much), such that, for the first signal being an input voltage signal having a relatively varying amplitude, the second signal in the form of an output current signal will have a relatively constant amplitude.

An embodiment of the control circuit is defined by the first regulator circuit comprising a first transistor, main electrodes of the first transistor being coupled to terminals of a main capacitor of the network circuit, and a control electrode of the first transistor being coupled to an output of a reference element. When being conductive, the first transistor bridges the main capacitor, resulting in an increased delay. Via the reference element, the first transistor is controlled.

An embodiment of the control circuit is defined by a control input of the reference element being coupled via one or more diodes to a common terminal of a serial connection for receiving the first signal. The serial connection acts as a voltage divider with or without introducing a phase-shift.

An embodiment of the control circuit is defined by the serial connection comprising a resistor and a capacitor. This voltage divider introduces a phase-shift.

An embodiment of the control circuit is defined by the serial connection comprising two capacitors of similar values to create a center point, one of these two capacitors being coupled in parallel to a further serial connection comprising a further resistor and a further capacitor, the one or more diodes being coupled to a common terminal of the further resistor and the further capacitor. This voltage divider creates a so-called center point in view of the four diode bridge.

An embodiment of the control circuit is defined by the control circuit further comprising
a second regulator circuit for in dependence of a load parameter signal delaying the control signal. Again, the control signal can be delayed, to control an amount of power transferred from the converter to the load. Preferably, for the load parameter signal having a relatively small (large) amplitude, the control signal is to be delayed relatively little (much), to create a negative feedback loop.

An embodiment of the control circuit is defined by the second regulator circuit comprising a second transistor, main electrodes of the second transistor being coupled to terminals of a main capacitor of the network circuit, and a control electrode of the second transistor being coupled to a control capacitor. When being conductive, the second transistor bridges the main capacitor, resulting in an increased delay. By charging and discharging the control capacitor, the second transistor is controlled.

An embodiment of the control circuit is defined by the control electrode further being coupled to a common terminal of a serial resistor connection to be coupled in parallel to at least a part of the load, the load parameter signal being an amplitude of a voltage signal present across the part the load. In this case, the amplitude of the voltage signal present across at least a part of the load is used for control.

An embodiment of the control circuit is defined by the control electrode further being coupled to a resistor to be coupled serially to at least a part of the load, the load parameter signal being an amplitude of a current signal flowing through the part of the load. In this case, the amplitude of the current signal flowing through at least a part of the load is used for control.

The first regulator circuit for in dependence of the first signal delaying the control signal and the second regulator circuit for in dependence of a load parameter signal delaying the control signal may be separate regulator circuits, that may be used separately or in combination, or may be combined into one regulator circuit for in dependence of the first signal and/or in dependence of one or more load parameter signals delaying the control signal.

According to a second aspect, a device is provided comprising the control circuit as defined above and further comprising the converter and/or the load.

An embodiment of the device is defined by further comprising
an inductor to be coupled serially between the converter and the load for supplying the second signal from the converter to the load, and
a supporting capacitor to be coupled in parallel to one or more branches comprising the load. The inductor gives the converter a current source behavior. The supporting capacitor may be necessary to allow an output current signal arriving via the inductor to keep on flowing in case the load is coupled to the inductor via one or more diodes that may be reversely biased in certain situations. The supporting capacitor should not be confused with one or more bulk capacitors coupled to the load. Usually, the supporting capacitor may be located at first sides of the one or more diodes, which first sides are further coupled to the inductor, where the one or more bulk capacitors may be located at second sides of the one or more diodes, which second sides are further coupled to the load.

The load for example comprises a light emitting diode circuit, such as a string of light emitting diodes or two anti-parallel strings of light emitting diodes. A light emitting diode circuit comprises one or more light emitting diodes of whatever kind and in whatever combination.

An insight is that a non-self-exciting-converter needs to be started. A basic idea is that a network circuit may be used for receiving the first signal and for deriving from the first signal a control signal destined for the converter for starting the converter after the zero-crossing of the input voltage signal.

A problem to provide a control circuit has been solved. A further advantage is that the control circuit is simple, low cost and robust and that it can be easily adapted to regulate a power transfer.

These and other aspects of the invention will be apparent from and elucidated with reference to the embodiments described hereinafter.

### BRIEF DESCRIPTION OF THE DRAWINGS

In the drawings:

FIG. 1 shows an embodiment of a device,

FIG. 2 shows an embodiment of a converter (prior art),

FIG. 3 shows a first embodiment of a control circuit,

FIG. 4 shows a second embodiment of a control circuit,

FIG. 5 shows a third embodiment of a control circuit,

FIG. 6 shows a load,

FIG. 7 shows a performance of the first and second embodiments, and

FIG. 8 shows a performance of the third embodiment.

### DETAILED DESCRIPTION OF EMBODIMENTS

In the FIG. 1, an embodiment of a device is shown. The device comprises a rectifier 300, a converter 100 with an input coupled to an output of the rectifier 300, a control circuit 1 with an input coupled to the output of the rectifier 300 and with one or more control outputs C₁, C₂ coupled to control inputs of the converter 100, and a load 200 with an input coupled to an output of the converter 100 and possibly with one or more control outputs coupled to one or more control inputs C₃, C₄ of the control circuit 1.

The rectifier 300 receives for example an alternating-current voltage signal from a mains supply and produces a direct-current voltage signal destined for the converter 100. The rectifier 300 comprises for example a four diode bridge common in the art, without having excluded other kinds of rectifiers that produce an output signal having zero-crossings. The converter 100 converts the output signal from the rectifier 300, further to be called a first signal, into a second signal destined for the load 200. The converter 100 is a non-self-exciting converter that stops converting at zero-crossings of the first signal.

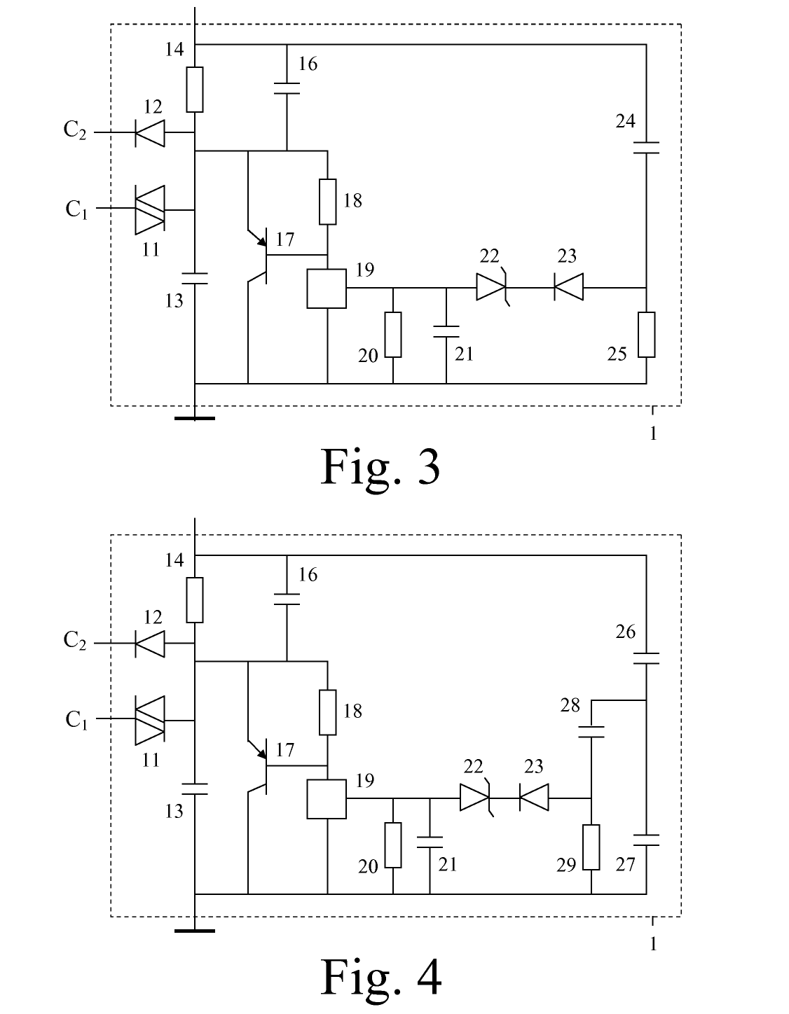

The control circuit 1 controls the converter 100 and comprises thereto a network circuit to be discussed at the hand of the FIG. 3-5 for receiving the first signal and for deriving from the first signal a control signal destined for the converter 100 for starting the converter 100 after the zero-crossing of the first signal.

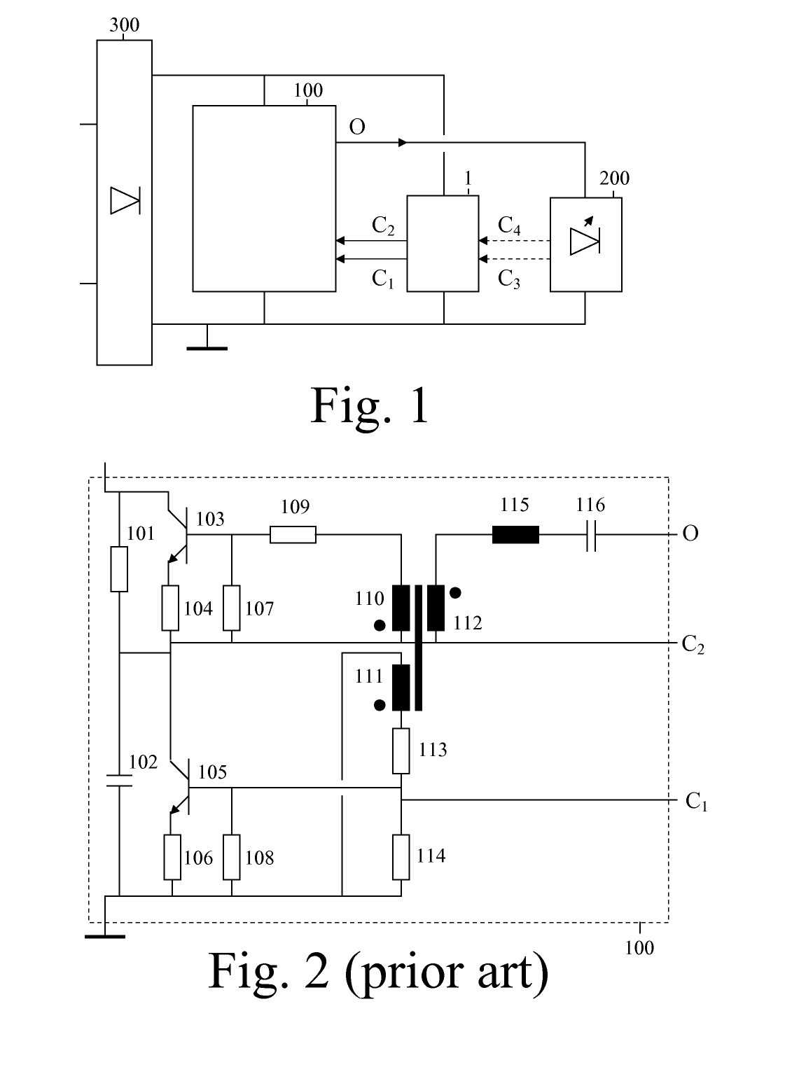

In the FIG. 2, an embodiment of a (prior art) converter 100 is shown. The converter 100 comprises a serial connection of a resistor 101 and a capacitive element 102 for receiving the first signal. The converter 100 comprises a switching element 103 here in the form of a transistor having a first main electrode coupled to one side of the resistor 101 and having a second main electrode coupled to one side of a resistor 104. Another side of the resistor 104 is coupled to another side of the resistor 101 and to one side of a resistor 107 and to one side of a first primary winding 110 of a transformer. Another side of the first primary winding 110 is coupled via a resistor 109 to a control electrode of the switching element 103 and to another side of the resistor 107.

The converter 100 comprises a switching element 105 here in the form of a transistor having a first main electrode coupled to one side of the capacitor 102 and having a second main electrode coupled to one side of a resistor 106. Another side of the resistor 106 is coupled to another side of the capacitor 102 and to one side of a resistor 108 and to one side of a resistor 114. Another side of the resistor 108 is coupled to a control electrode of the switching element 105 and to another side of the resistor 114 and to one side of a resistor 113. Another side of the resistor 113 is coupled to one side of a second primary winding 111 of the transformer. Another side of the second primary winding 111 is coupled to the one side of the resistors 108 and 114.

The transformer further comprises a secondary winding 112 with one side coupled to one side of an inductor 115 and with another side coupled to the one side of the first primary winding 110. Another side of the inductor 115 is coupled to one side of a direct-current blocking capacitor 116, and another side of the direct-current blocking capacitor 116 forms the output O of the converter 100. The control electrode of the switching element 105 forms a first control input to be coupled to a first control output C₁ of the control circuit 1, and the other side of the secondary winding 112 forms a second control input to be coupled to a second control output C₂ of the control circuit 1. Alternatively, the inductor 115 and/or the direct-current blocking capacitor 116 may be located outside the converter 100, between the converter 100 and the load 200 or as a part of the load 200.

The converter 100 may further comprise a parallel circuit of a filtering capacitor and a resistor at the input of the converter 100 and coupled in parallel to the serial connection and may further comprise another inductor coupled serially between the output of the rectifier 300 and the input of the converter.

In the FIG. 3, a first embodiment of a control circuit 1 is shown. The control circuit 1 comprises a network circuit 11-16 also discussed before. The network circuit 11-16 comprises a serial connection of a resistor circuit 14 and a main capacitor 13. Here, the resistor circuit 14 comprises a resistor 14. The serial connection receives the first signal. The network circuit 11-16 further comprises break-over-circuitry 11 such as for example a diac. A common terminal of the resistor circuit 14 and the main capacitor 13 is coupled to one terminal of the break-over-circuitry 11, another terminal of the break-over-circuitry 11 forms a first control output C₁ of the control circuit 1 for controlling the switching element 105 of the converter 100 via the control signal, as follows: Via the resistor circuit 14, the main capacitor 13 is charged. As soon as the main capacitor 13 has been charged sufficiently, the break-over-circuitry 11 experiences a so-called break-over and the control signal in the form of a pulse is supplied to the switching element 105 of the converter 100 for starting the converter 100.

Possibly, the network circuit 11-16 further comprises a diode 12. A common terminal of the resistor circuit and the main capacitor 13 is coupled to one terminal of the diode 12, another terminal of the diode 12 forms a second control output C₂ of the control circuit 1 for controlling the capacitive element 102 of the converter 100, as follows: Via the diode 12, the capacitive element 102 of the converter 100 is controlled such that it is kept discharged until the converter 100 has been started via the control signal.

Preferably, to improve a performance of the network circuit 11-16, it may further comprise an auxiliary capacitor 16 coupled in parallel to one or more resistors of the resistor circuit 14.

To regulate an amount of power transferred from the converter 100 to the load 200, the control circuit 1 may further comprise a first regulator circuit 17-29 for in dependence of the first signal delaying the control signal. A larger delay of the control signal will result in a later start of the converter 100 and in a reduced amount of power being transferred to the load 200. The first regulator circuit 17-29 may comprise a first transistor 17. Main electrodes of the first transistor 17 are coupled to terminals of the main capacitor 13 of the network circuit 11-16, and a control electrode of the first transistor 17 is coupled to an output of a reference element 19, such as for example a TL431BCD that acts as an ideal switch and that is conductive and stays conductive until a control voltage at its control input has reached a predefined value. As long as the first transistor 17 is conductive, the first transistor 17 bridges the main capacitor 13, and it cannot be charged. This results in an increased delay. Via the reference element 19, the first transistor 17 can be controlled.

The control electrode of the first transistor 17 is, just like a first main electrode of the first transistor 17, further coupled via a resistor 18 to the auxiliary capacitor 16 and to the resistor 14. A second main electrode of the first transistor 17 is coupled to ground, just like the reference element 19. A control input of the reference element 19 is coupled via a parallel circuit of a resistor 20 and a capacitor 21 to ground and via a zener diode 22 and a diode 23 to a common terminal of a serial connection for receiving the first signal. In this case, the reference element 19 and the first transistor 17 are controlled in dependence of a derived value of the first signal coming from the rectifier 300. The serial connection may comprise a resistor 25 and a capacitor 24, in which case the derived value will experience a phase-shift in view of the first signal.

In the FIG. 4, a second embodiment of a control circuit 1 is shown that only differs from the first embodiment shown in the FIG. 3 in that the serial connection here comprises two capacitors 26, 27 of similar values to create a center point, in which case the derived value will be comparable to a center value as present in the rectifier 300. One of these two capacitors 26, 27 is coupled in parallel to a further serial connection comprising a further resistor 29 and a further capacitor 28. The diode 23 is then coupled to a common terminal of the further resistor 29 and the further capacitor 28.

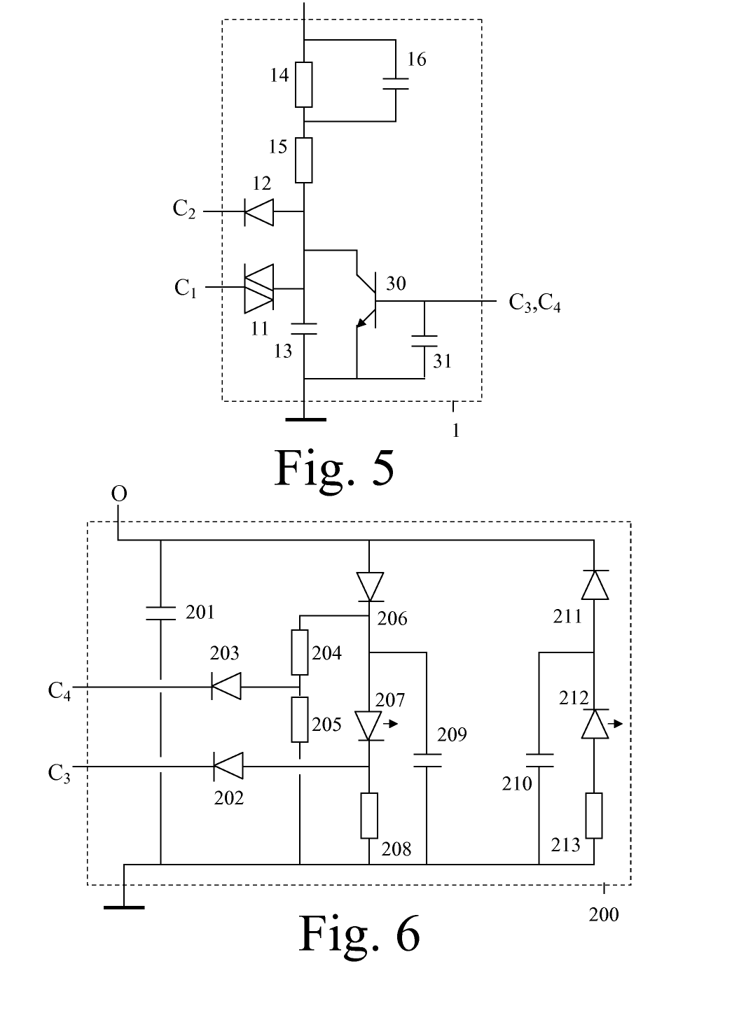

In the FIG. 5, a third embodiment of a control circuit 1 is shown. This control circuit 1 further comprises, in addition to the network circuit 11-16, a second regulator circuit 30, 31 for in dependence of a load parameter signal delaying the control signal. Again, an amount of power transferred from the converter 100 to the load 200 is regulated, but now in dependence of a load parameter signal. The second regulator circuit 30, 31 may comprise a second transistor 30. Main electrodes of the second transistor 30 are coupled to terminals of the main capacitor 13 of the network circuit 11-16. A control electrode of the second transistor 30 is coupled to a control capacitor 31. This control circuit 1 has two control inputs C₃, C₄ here realized via one and the same terminal for receiving information about different load parameters. Further, in the FIG. 5, the resistor circuit comprises two serially coupled resistors 14 and 15, whereby the auxiliary capacitor 16 is coupled in parallel to the resistor 14.

In the FIG. 6, a load 200 is shown. The load 200 comprises a first serial branch (master) with a diode 206, one or more light emitting diodes 207 of whatever kind and in whatever construction and a resistor 208. In parallel to the light emitting diodes 207 and the resistor 208, a bulk capacitor 209 is present. The load 200 comprises a second serial branch (slave) with a diode 211, one or more light emitting diodes 212 of whatever kind and in whatever construction and a resistor 213. In parallel to the light emitting diodes 212 and the resistor 213, a bulk capacitor 210 is present. The first and second serial branches are so-called anti-parallel branches that receive the second signal from the output O of the converter 100.

A common point between the light emitting diodes 207 and the resistor 208 is coupled to one side of a diode 202, the other side of the diode 202 is to be coupled to the first control input C3 of the control circuit 1. A common point between the light emitting diodes 207 and the diode 206 is coupled to a serial connection of two resistors 204, 205. A common point of these two resistors 204, 205 is coupled to one side of a diode 203, the other side of the diode 203 is to be coupled to the second control input C4 of the control circuit 1. Via the first control input C3 of the control circuit 1, information about the load parameter signal in the form of an amplitude of a current signal flowing through the light emitting diodes 207 is supplied to the control capacitor 31. Via the second control input C4 of the control circuit 1, information about the load parameter signal in the form of an amplitude of a voltage signal present across the light emitting diodes 207 is supplied to the control capacitor 31. As long as values of these load parameter signals are too large, the control capacitor 31 will have a too large charge, and the second transistor 30 will be conductive etc.

Further, in parallel to the first and second serial branches, a supporting capacitor 201 is present to allow a current signal arriving from the output O of the converter 100 to keep on flowing in case the diodes 206 and 211 are reversely biased. Alternatively, the supporting capacitor 201 may be located inside the converter 100 or may get a location between the converter 100 and the load 200.

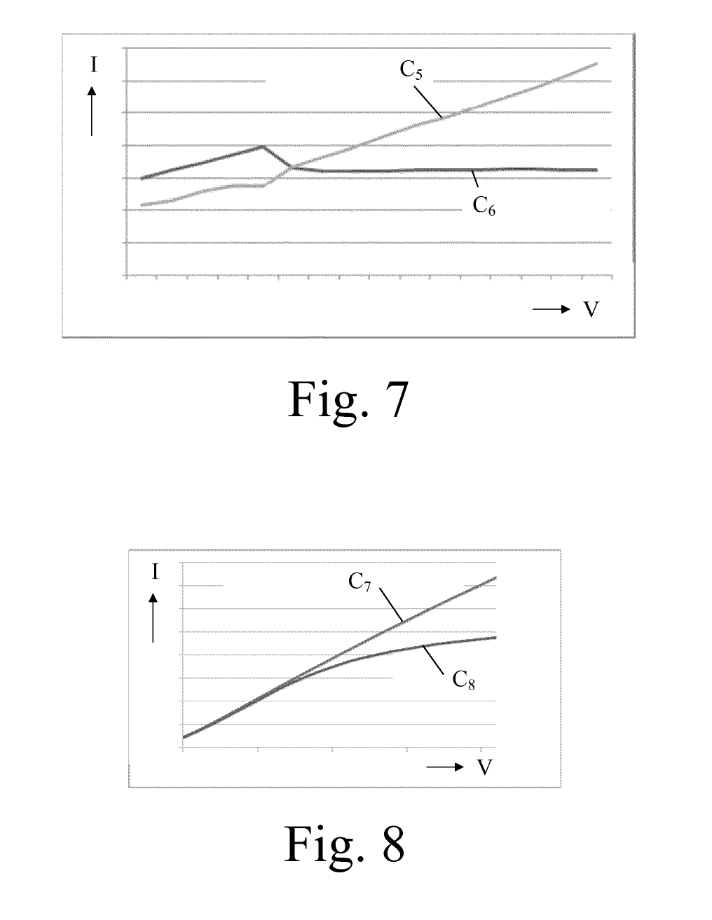

In the FIG. 7, a performance of the first and second embodiments is shown. The horizontal axis defines an amplitude of a voltage signal provided by the rectifier 300 (the first signal) and the vertical axis defines an amplitude of a current signal flowing through the load 200. The graph C₅ is without regulation and the graph C₆ results from the first regulator circuit 17-29 being active. Clearly, a more stable performance has been reached.

In the FIG. 8, a performance of the third embodiment is shown. The horizontal axis defines an amplitude of a voltage signal provided by the rectifier 300 (the first signal) and the vertical axis defines an amplitude of a current signal flowing through the load 200. The graph C₇ is without regulation and the graph C₈ results from the second regulator circuit 30, 31 being active. Clearly, a more efficient performance has been reached. Once a light emitting diode has reached its optimum point, it would be of no use to increase the current going into that light emitting diode.

As an example only, at an amplitude of 180 Volt of the first signal a delay may be 1.2 msec. and at an amplitude of 300 Volt of the first signal a delay may be 5.5 msec. for half a period of the first signal for example being 10 msec.

Two elements that are coupled to each other may be coupled directly without a third element being in between or may be coupled indirectly with a third element being in between. The FIG. 2-6 are examples only, each element may be replaced by two or more serial elements or by two or more parallel elements or by mixtures thereof. Each diode may be replaced by (a part of) a transistor, each transistor may be replaced by another switching element, each break-over-circuitry may comprise another element than a diac but having a similar function, capacitors may be replaced by serial or parallel connections of capacitors and resistors, inductors may be replaced by serial or parallel connections of inductors and resistors, inductors may be replaced by transformers or parts thereof and may form part of transformers etc. Instead of ground, another reference potential may be used etc.

Summarizing, control circuits 1 for controlling non-self-exciting converters 100 are provided with network circuits 11-16 for deriving control signals destined for the converters 100 for starting the converters 100 after zero-crossings of first signals that enter the converters 100. These control signals are derived from the first signals. The network circuits 11-16 may comprise serial connections of resistor circuits 14, 15 and main capacitors 13 and may comprise break-over-circuitry 11 for controlling switching elements 105 of the converters 100 via the control signals. The control circuits 1 may further comprise first regulator circuits 17-29 for, in dependence of the first signals, delaying the control signals to control an amount of power transferred, and may further comprise second regulator circuits 30, 31 for, in dependence of one or more load parameter signals, delaying the control signal to control an amount of power transferred.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1.-13. (canceled)

14. A device comprising a converter, an inductor, a supporting capacitor and a load, wherein said converter is configured to convert a first signal into a second signal and comprises a first switching element and a second switching element in series which are alternatively in a conductive and non-conductive state;
wherein said inductor is serially coupled between the load and the interconnection of the first switching element and the second switching element, for supplying a second signal from the converter to the load, and
the supporting capacitor is coupled in parallel to the load;
and wherein the load comprises:
two anti-parallel branches that receive the second signal from an output of the converter, a first branch comprising one or more first light emitting diodes and a second branch comprising one or more second light emitting diodes reversely forwarded with respect to the first light emitting diodes.

15. A device as defined in claim 14, wherein said supporting capacitor is adapted for being charged via the inductor, when the first switching element is in a conductive state so as to power the first branch; and adapted for discharging and providing power via said inductor when the second switching element is in a conductive state, in order to power the second branch.

16. A device as defined in claim 14, wherein said first branch further comprises a first diode and a first resistor in serial connection with said first light emitting diodes; and said second branch further comprises a second diode and a second resistor in serial connection with said second light emitting diodes.

17. A device as defined in claim 16, wherein said first branch further comprises a bulk capacitor in parallel with the series connection of said first light emitting diodes and the first resistor; and said second branch further comprises a bulk capacitor parallel with the series connection of said second light emitting diodes and the second resistor.

18. A device as defined in claim 14, wherein said converter further comprises a transformer with a secondary winding, a first primary winding and a second primary winding, wherein said secondary winding is in series between the first switching element and the inductor, said first primary winding is coupled to the control electrode of the first switching element, and said second primary winding is coupled to the control electrode of the second switching element.

19. A device as defined in claim 18, wherein the converter further is of a kind that stops converting at the zero-crossing of the first signal, the converter comprising a network circuit for receiving the first signal and for deriving from the first signal a control signal destined for the converter for starting the converter after the zero-crossing of the first signal, the network circuit comprising a serial connection for receiving the first signal.

20. A device as defined in claim 19, wherein said serial connection comprises a resistor and a main capacitor, the interconnection of the resistor and the main capacitor is coupled to the control electrode of the first switching element via a diode and the first primary winding.

21. A device as defined in claim 20, wherein the converter further comprises:
a second regulator circuit for in dependence of a load parameter signal delaying the control signal.

22. The device as defined in claim 21, the second regulator circuit comprising a second transistor, main electrodes of the second transistor being coupled to terminals of the main capacitor of the network circuit, and a control electrode of the second transistor being coupled to a control capacitor.

23. The device as defined in claim 22, the control electrode further being coupled to a common terminal of a serial resistor connection to be coupled in parallel to at least a part of the load, the load parameter signal being an amplitude of a voltage signal present across the part of the load.

24. The device as defined in claim 22, the control electrode further being coupled to a resistor to be coupled serially to at least a part of the load, the load parameter signal being an amplitude of a current signal flowing through the part of the load.

25. A device as defined in claim 19, wherein the converter further comprises a break-over-circuitry coupled from the interconnection of the resistor and the main capacitor to the control electrode of the second switching element.

26. A device as defined in claim 20, further comprising
a first regulator circuit for in dependence of the first signal delaying the control signal.

27. A device as defined in claim 26, wherein the first regulator circuit comprises a first transistor, main electrodes of the first transistor being coupled to terminals of the main capacitor of the network circuit, and a control electrode of the first transistor being coupled to an output of a reference element.

28. A device as defined in claim 27, wherein a control input of the reference element is coupled via one or more diodes to a common terminal of a serial connection for receiving the first signal, wherein said serial connection comprises:
a resistor and a capacitor; or
two capacitors of similar values to create a center point, one of these two capacitors being coupled in parallel to a further serial connection comprising a further resistor and a further capacitor, the one or more diodes being coupled to a common terminal of the further resistor and the further capacitor.
